(19) United States
(12) Patent Application Publication
(10) Pub. No.: US 2026/0298414 A1
(43) Pub. Date: Oct. 1, 2026

(54) STORAGE DEVICE

(71) Applicant: Polar Technology Management Group Limited, Oxfordshire (GB)

(72) Inventor: Michael Dewhirst, Oxfordshire (GB)

(21) Appl. No.: 18/996,258

(22) PCT Filed: Jul. 18, 2023
(86) PCT No.: PCT/GB2023/051886

§ 371 Date: Jan. 17, 2025

(30) Foreign Application Priority Data
Jul. 18, 2022 (GB) 2210492.1

(51) Int. Cl. F17C 13/08; F17C 1/06

(52) U.S. Cl. CPC F17C 13/084; F17C 1/06; F17C 2201/0109; F17C 2201/0166; F17C 2203/0665; F17C 2205/0107; F17C 2205/0142; F17C 2221/012; F17C 2223/036; F17C 2260/011

(57) ABSTRACT

A storage tank assembly (10B) for a pressurised fluid, the assembly comprising a plurality of individual vessels (60), arranged adjacent to each other, such that pressure from adjacent vessels, when pressurised, provides mutual support for vessel wall structures between them, wherein the individual vessels are tubular structures closed with cap structures (68), and wherein the storage tank assembly (10B) further comprises one or more support structures (64A, 64B) to support the cap structures (68). The support structures (64A, 64B) increase the pressure rating of the individual vessels (60).

### FIELD OF THE INVENTION

The present invention relates to a storage device for pressurised gas, particularly for hydrogen. More specifically, the present invention relates to a hydrogen fuel cartridge.

### BACKGROUND

Hydrogen tanks for use in motorised vehicles such as in the haulage industry may be provided in the form of exchangeable batteries or cartridges and/or may be integrated with a vehicle. A more widespread use of hydrogen tanks requires several practical aspects to be addressed. The cartridges may have to fit into a pre-defined geometry. Likewise, there are aspects of storage of the cartridges, ease of replacement, ease of refuelling, and ease of handling in general.

At usual application temperatures, hydrogen is present in gas form and needs to be pressurised to several hundred bar. As such, hydrogen storage tanks need to withstand significant pressures, which imposes structural demands on hydrogen storage tanks. To provide an illustrative example, the hydrogen mass of a typical hydrogen storage device today, when filled with hydrogen, may make up only about 4-10% of the devices mass, the remaining mass being container structure that is required for a sufficient pressure rating.

Known hydrogen storage devices may therefore have a mass that contributes to the overall weight of a vehicle, and may also be difficult to handle as a single person or two-person lift even in an empty condition.

The present invention seeks to provide an improved pressurised fluid storage device, or tank, that ameliorates at least some of the aforementioned problems.

### SUMMARY OF THE INVENTION

In accordance with a first aspect of the invention, there is disclosed a storage tank assembly for a pressurised fluid, as defined in claim 1, the assembly comprising a plurality of individual vessels arranged adjacent to each other, such that pressure from adjacent vessels, when pressurised, provides mutual support for vessel wall structures between them, wherein the individual vessels are tubular structures closed with cap structures, and wherein the storage tank assembly further comprises one or more support structures to support the cap structures.

A vessel can be understood as a chamber or cell configured to hold pressurised fluid, such as hydrogen gas. The vessel will be defined by a vessel wall structure, such as a generally cylindrical housing. The arrangement allows a pressurised vessel to provide a support function for an adjacent vessel wall structure. In a simple arrangement, two vessel cells that are pressurised may provide mutual support for one or more vessel wall structures between them. In this manner, the vessel wall structures may be designed less strong than they would otherwise need to be in the absence of an adjacent vessel.

In other words, the storage tank assembly is arranged allow filling of adjacent vessels with pressurised fluid in such a manner that at least a few of the vessel wall structures are supported by adjacent pressurised chambers and thereby capable of withstanding a higher pressure level than would otherwise be the case.

A pressure level that a vessel can withstand in the absence of support structures may be considered a first pressure level. The first pressure level may be a pressure threshold between a safe pressure level and an excess pressure level, or maximum pressure level. The first pressure level is understood to be specification dependent, and may depend on temperature ranges, material and other factors. However, it will be appreciated that for a given set of conditions, the vessel wall structure may fail if subjected to excess load. The claimed arrangement provides a higher pressure rating to the vessel wall structure by mutual support of a vessel wall structure using pressurised vessels, or cells on both sides of a wall structure.

Using an example of hydrogen pressurised to about 700 bar, a typical vessel wall structure of an isolated vessel may have to withstand a pressure difference of several hundred (e.g. 700) bar on one side (i.e. the inside) of a vessel and a significantly lower pressure, e.g. atmospheric pressure on another (i.e. the outside) of the vessel. By way of the present arrangement, a vessel wall structure may by design need to withstand a smaller pressure difference. To provide an example, if the pressures on either side of a wall differ by about 10%, e.g. 700 bar on one side and 630 bar on the other side, the resulting pressure difference may be 70 bar, i.e. much less than a 700 bar difference.

The pressure is understood to be outward acting pressure, resulting in stress on the vessel walls, of pressurised fluid within a vessel. To provide an illustrative example, pressurised hydrogen may have in excess of 500, 600 or 700 bar. The invention is, however, not necessarily limited to hydrogen gas and may also be used in other tanks for pressurised fluids.

The cap structure may be a flat cap. The cap structure may be a domed cap. The cap structure may be a hemispherical shape. A cap structure may cover one vessel end, or may cover two or more vessel ends.

The support structures may be provided in the form of walls or tensioned elements to strengthen free sides of the assembly. Free sides are understood to be sides not supported, or not supportable, by an adjacent pressure vessel.

The assembly may comprise a configuration allowing pressure equilibration between two or more vessels.

The configuration may be provided by one or more manifolds providing fluid passages connecting two or more vessels, thereby facilitating pressure equilibration between the two or more vessels. The configuration may be provided by a control system comprising a pressure sensor arrangement, the sensor arrangement operated to provide an indication of a pressure level, and the control system configured to maintain (including filling and/or withdrawing, increasing or decreasing pressure) in adjacent vessels to within a pre-defined pressure range based on the indication of the pressure level.

It will be appreciated that the net pressure difference between two adjacent vessels determines the required vessel wall strength a vessel wall structure must be able to withstand. By providing a better pressure equilibrium, as will be appreciated amounts to a smaller or no difference in pressure, less strong vessel wall structures may be used.

While it may be desirable to pressurise vessels homogeneously, for practical reasons such as flow rates, control element response times, valve actuation times, length and layout of feeding lines, and other reasons, it may not be possible to ensure perfect equilibrium at all times. As such, the configuration may allow a pressure difference of no more than 2%, 3%, 4%, 5%, 6%, 7%, 8%, 9%, 10% between two adjacent vessels. The configuration may allow a pressure difference of no more than 5bar, 10bar, 20bar between two adjacent vessels. The difference is understood to be dependent on the strength of the vessel wall structure, and a larger difference may be tolerated with stronger wall structures.

The one or more support structures may be provided on free sides of one or more vessels.

Vessel wall structures of a vessel, or chamber, may comprise portions adjacent to another vessel, and other portions without an adjacent vessel. Such other portions are, herein, considered free sides, i.e. sides of a vessel wall structure not supported by an adjacent pressurised vessel.

In some embodiments, the one or more support structures comprise one or more end plates.

The end plates may be used to provide structural support. Pairs of end plates are believed to be a practical embodiment providing structural support to free sides of two or more vessels. Specifically, the end plates may be under tension to thereby assist with retaining the cap structures on the vessels.

In some embodiments, the end plates comprise a surface profile complementing a surface profile of the cap structures.

In some embodiments, the cap structures comprise domed cap structures.

As will be appreciated, the end plates may comprise a surface profile that is concavely shaped, respectively, shaped corresponding to the surface profile of the cap structures.

The surface profile is believed to allow a better surface-to-surface contact to be provided between an end plate that the cap structures with which it is in abutment.

In some embodiments, the assembly comprises one or more pairs of end plates, the end plates of a pair provided with a plate-supporting arrangement thereby to reinforce the cap structures.

The plate-supporting arrangement may be provided, or constituted, by a tensionable mechanism.

End plates may be provided as a common end plate for a plurality of vessel, and thereby as a common support for a plurality of end caps.

The support structure plates constitute additional support elements that may be integral with a tank assembly. By “common” end plate, an end plate is meant that supports the cap structures of multiple vessels.

In some embodiments, the plate-supporting arrangement comprises components in the form of rods.

In some embodiments, the plate-supporting arrangement comprises components in the form of bands.

In some embodiments, one or more of the bands are provided in hoop form.

The plate-supporting arrangement may be provided by a single hoop, or belt. In some embodiments, the assembly comprises two belt arrangements, one extending laterally between and parallel to two end plates, and one wrapping around two end plates. The bands may be of unitary, continuous form. For instance, the bands may be a fibre-reinforced composite material.

In some embodiments, one or more of the bands are anchored to an external structure of one or both end plates.

In some embodiments, multiple bands are anchored to a common external structure.

In some embodiments, one or more plate-supporting components extend along interstitial spaces between individual vessels.

In some embodiments, one or more plate-supporting components extend outside of laterally outermost vessels.

In some embodiments, the one or more support structures comprise one or more belt structures provided circumferentially around the plurality of vessels.

In some embodiments, one or more of the belt structures surround two opposite vessels, thereby to allow mutual transfer of loads between the opposite vessels.

A support structure may be provided by one or more hoops providing a belt structure. The hoops may be provided by short sections of tubular structures, or other suitable structures. The belt structure may surround an array of two or more vessels, to provide structural support to free sides of outer vessels that are not located between two adjacent vessels. The opposite vessels may be two outermost vessels of an array of vessels.

The belt structure may be made from the same material as the vessel wall structures, however this is not necessarily the case in all embodiments and the belt structure may be made from different materials. The belt structure may be stronger than the vessel wall structure, for instance it may have a higher pressure rating. The belt structure may have the same strength as the vessel wall structure, e.g. may be made from the same material and thickness. The belt structure may have the same pressure rating as the vessel wall structure, capable of withstanding the first pressure level.

In some embodiments, one or more plate-supporting components extend outside the one or more belt structures.

In some embodiments, the vessel wall structure is of reinforced composite material form.

For instance, the composite material may be a fibre-reinforced composite material.

The wall structure material is made from a material composition suitable for containing the pressurised liquid.

In some embodiments, at least one cap structure is integral with a tubular portion of a vessel.

As will be appreciated, several or all cap structures may be integrally formed with tubular portions of the vessels.

In some embodiments, at least one cap structure is a separate component attached to a tubular portion of a vessel.

Several, or all, cap structures may be formed as separate components to be attached to tubular portions of the vessels.

In some embodiments, the assembly comprises a frame structure in which the vessels are held.

The frame structure may be provided by parts of, and/or may be constituted by, the afore-mentioned support structure. Two or more different types of support structure may be used in an assembly to form a frame structure. For instance, one or more belt structures may provide lateral support for free vessel sides, around the axes of two or more vessels, and pairs of end plates may provide support for end caps of two or more vessels. In addition, one or more belt structures may provide plate-supporting structures wrapped around or otherwise connected to the two end plates.

In some embodiments, the frame structure comprises end plates in abutment with the ends of the vessels.

The end plates of a frame structure and/or of a support structure may be in abutment with the ends of one or more vessels. For instance, the end plates may provide support for end caps of one or more vessels, to increase the pressure threshold at which the end caps might otherwise blow out or detach. Thereby, it can be ensured that the end caps withstand a minimum required pressure level.

In some embodiments, the frame structure comprises one or more fluid ports suitable as an inlet and/or outlet for gas exchange with the vessels.

In some embodiments, one or more fluid ports are provided on a support structure.

In some embodiments, two or more fluid ports are in fluid connection with a manifold configured to permit pressure equilibration between two or more vessels.

In some embodiments, the assembly forms part of a pressurised fluid container.

In some embodiments, the assembly forms part of a hydrogen fuel tank.

The invention is believed to be suitable for the storage of pressurised fluids, primarily hydrogen but also other fluids such LPG.

### DESCRIPTION OF THE FIGURES

Exemplary embodiments of the invention will now be described with reference to the Figures, in which:

FIG. 1 shows a schematic isometric view of an embodiment;

FIG. 2 shows a section along the line 2-2 in FIG. 1;

FIG. 3 shows an enlarged view of a portion of FIG. 2;

FIG. 4 shows a cutaway side view of the FIG. 1 embodiment;

FIG. 5 shows a cutaway side view of another embodiment;

FIG. 6 shows a cutaway isometric view of another embodiment;

FIG. 7 shows an isometric view of the FIG. 6 embodiment;

FIG. 8 shows another cutaway view of the FIG. 6 embodiment;

FIG. 9 shows a top view of the FIG. 6 embodiment; and

FIG. 10 shows an end view of the FIG. 6 embodiment.

### DESCRIPTION

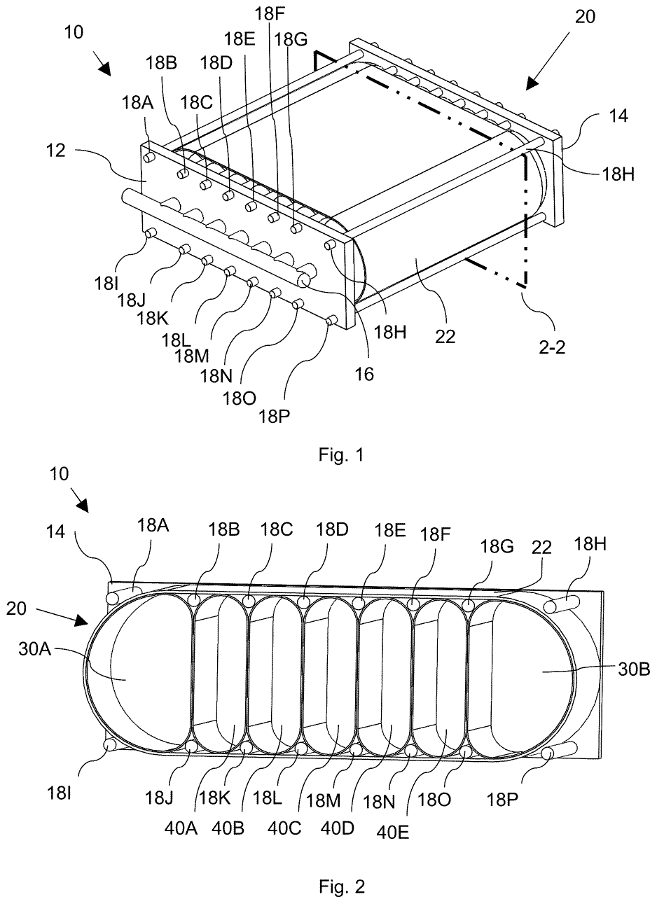

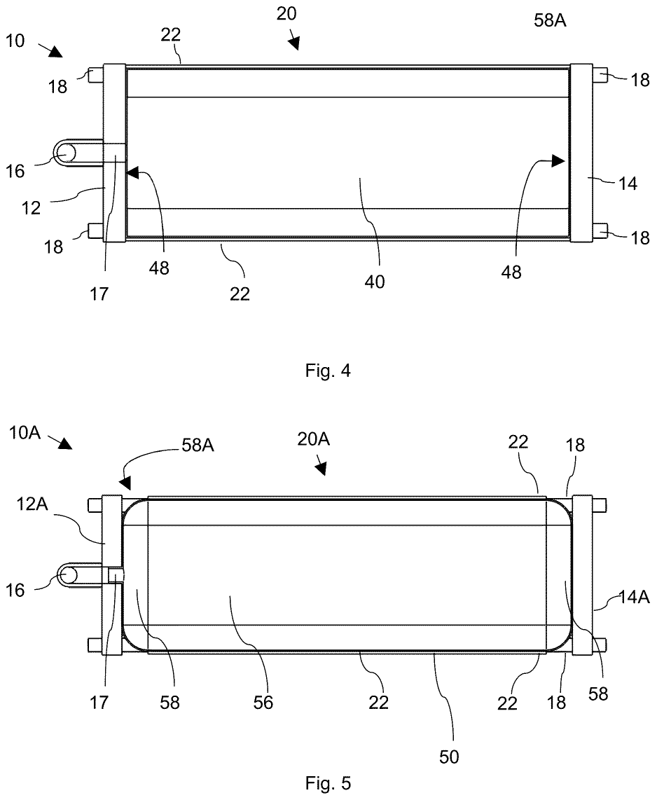

Referring to the Figures, FIGS. 1 to 4 shows different views of a hydrogen tank module 10 constituting a storage tank assembly. The module 10 comprises a frame structure comprised of a first end plate 12 and a second end plate 14, the first and second end plates 12, 14 being connected by a series of connecting rods 18. As illustrated, the frame structure comprises a plurality of (here: 8) first connecting rods 18A, B, C, D, E, F, G, H and a plurality of (here: 8) second connecting rods 18I,J, K, L, M, N, O, P, collectively referenced as rods 18. The rods 18 maintain the first end plate 12 and the second end plate 14 in a spaced-apart relation. The rods 18 are tensionable, by a suitable means such as threaded connections, so as to allow the first end plate 12 and the second end plate 14 to be tensioned relative to each other. It will be appreciated that the rods are one example of a connecting structure for joining the first and second end plates 12, 14 in a spaced-apart configuration.

The end plates 12, 14 and rods 18 may be of a suitable material for load-bearing purposes, such as metal or reinforced composite material. In the present embodiment, the end plates 12, 14 and the rods 18 are made from steel, however, they may also be made from aluminium or other suitable materials. The end plates 12,14 are illustrated as solid plates, however the plates may also comprise apertures or a lattice structure.

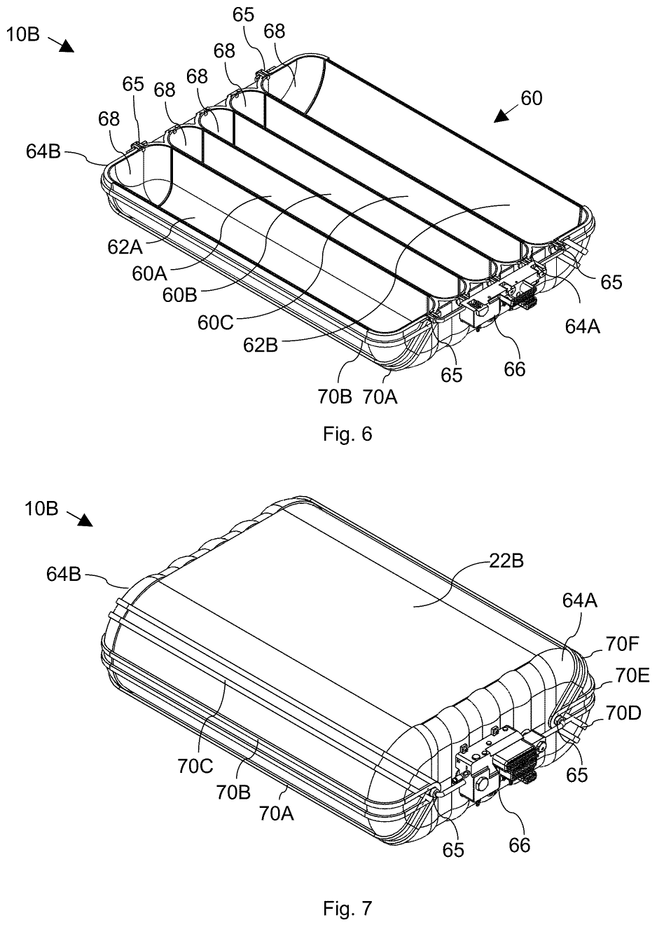

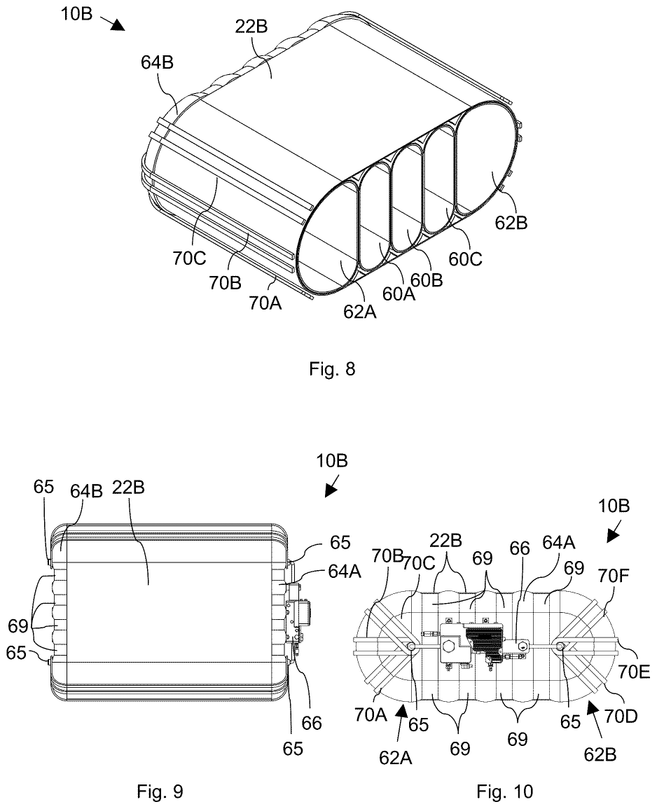

Herein, the first and second end plates 12, 14 each have a rectangular silhouette arranged in parallel such that the frame structure of the module 10 takes a generally cuboid form or slab form. The cuboid form is believed to be useful where the hydrogen tank module is intended as a cartridge to fit into pre-defined battery envelopes. However, it will be appreciated that the frame structure may take any other form, such as using round, hexagonal, square or other end plate shapes, for corresponding cylindrical, polygonal, or more complex shapes, such as a scalloped silhouette illustrated in FIGS. 6-10.

The frame structure is provided as part of a support structure for a vessel array 20. The vessel array 20 is constituted by a plurality of individual vessel units 30, 40. Each vessel unit 30, 40 is a container providing a chamber suitable for storing compressed fluid. For instance, the vessel unit may be designed to store compressed hydrogen at room temperature.

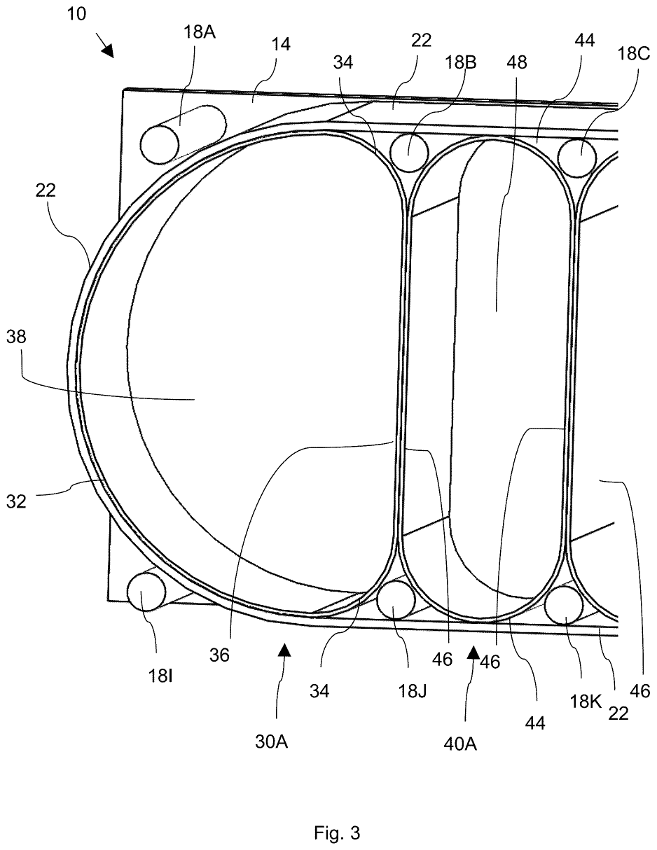

With reference to FIGS. 2 and 3, the vessel array 20 comprises, in this example, two different types of vessel, including lateral vessels 30 (here: two lateral vessels 30A and 30B) and intermediate vessels 40 (here: five intermediate vessels 40A, B, C, D, E). Each vessel may, when part of the module 10, be defined by a pressure-resisting vessel wall suitable for containing highly pressured fluid, of at least 100 bar, 200 bar, 300 bar, 400 bar, 500 bar or more. For hydrogen storage at room temperatures and typical temperatures ranges below and above room temperature in which a vehicle may be used, the vessel walls may have to be able to withstand pressures exceeding 600 bar or 700 bar.

It will be appreciated that the nominal pressure level of a vessel may be defined by the vessel wall thickness, material, shaping, and wall properties. The vessel walls may be of composite material form, and may be reinforced material, such as fibre reinforced material. The vessel walls may be made from woven fibre embedded in a resin matrix. The vessel walls may comprise several layers of composite material, the layers embedded in a cured resin matrix to form a unitary wall structure.

In accordance with the invention, an individual vessel wall structure may withstand a first pressure level that may be less than a target pressure, e.g. lower that a hydrogen storage pressure rating. For instance, a vessel wall structures may withstand 200 bar, 300 bar, 400 bar, 500 bar, or 600 bar, or significantly less e.g. 50 bar or 100 bar difference between the pressures on both sides of the vessel wall structure. The ability of an individual vessel to safely contain fluid pressurised above the first pressure level, e.g. at 700 bar, is imparted by one or more support configurations of the invention, which allow the vessel as part of the array to withstand a pressure that is higher than the first pressure level.

FIG. 3 shows an enlarged view of a portion of FIG. 2 to show the lateral vessel 30A and the intermediate vessel 40A. The lateral vessel 30A has a tubular body a side of which is formed with a flat face 36, such that the cross-section of the tubular body approximates a semicircle or “D” shape, defined by a round face 32 and the flat face 36. The radius of the rounder face 32 may be circular or may approximate a circular shape. The contour of the tubular body is rounded such that the corners 34 joining the rounder side 32 and the flat side 34 are curved.

The intermediate vessel 40A has a tubular body formed with two opposite flat faces 46 connected via generally semicircular, opposite ridges 44, the cross-section of the tubular body being of obround or general “lozenge” form. An obround cross-section is believed to be practical for a linear array of vessels, because it provides opposite flat faces 46 and a generally stabilising curved or semicircular ridge 44 at free ends, however other geometries may be used.

The lateral vessels 30 and the intermediate vessels 40 are arranged parallel to each other, parallel to the rods 18, such that the ends of the lateral vessels 30 and the intermediate vessels 40 face the inside surfaces of the first and second end plates 12, 14. The vessels are oriented such that the flat face 36 of a lateral vessel 30A abuts a lateral face 46 of an intermediate vessel 40A. Several intermediate vessels 40 may be arranged in series, as illustrated in FIG. 2, such that the flat faces 46 of one intermediate vessel 40A are in abutment with the adjacent flat faces 46 of a respective other intermediate vessel 40B, etc, or with the flat face 36 of a lateral vessel 30A,30B.

It will be appreciated that the module 10 is of scalable design, such that any number of intermediate vessels 40 may be provided according to capacity and/or space demand. The flat faces 36, 46 reduce the interstitial space between the adjacent wall structures, and therefore increase the surface area of planar extensions of the vessel wall structure. This provides a large surface for pressure to act evenly from both sides of the vessel wall structure. While the arrangement of FIGS. 2 and 3 is illustrated as a linear series of vessels forming a row, or a linear array, the invention is not so limited and vessels may be arranged in multiple rows. In this case, wall portions of the tubular vessel structures that come into abutment with adjacent vessel may be formed as flat faces that are not necessarily opposite sides. As may be imagined for corner locations, the vessel wall structures may comprise two flat sides at a right angle to each other. Similarly, in edge locations a vessel wall structure may comprise three flat sides, for instance when used in a two-row arrangement. The vessel walls may comprise four flat sides for inner positions when used in an arrangement with three or more rows.

As shown in FIGS. 2 and 3, the vessels are arranged linearly and vertically in registration with each other. However, it will be appreciated that the vessels may be arranged in multiple rows that are either in registration or offset, for instance in a hexagonal arrangement. The vessel array may be designed as a honeycomb structure, may be designed using two-dimensional crystal theory and/or tessellation algorithms. However, without wishing to be bound by theory, for practical purposes is it is believed that a low number of (here: two) different vessel shapes, such as a combination of a semicircular tube profile and an obround tube profile, allows for a cost-effective manufacturing process.

A particular aspect of using tubular structures such as the semicircular or obround shapes suggested herein is that the tubes may be formed of any length and cut to size as required. In this manner, the manufacturing process may be separated in a tube-forming process, and an assembly process for the manufacture of a module from pre-fabricated tubes.

The vessel wall structures are closed off with end caps 38, 48 corresponding in shape to the mantle profile of the tubular structures, i.e., semicircular end caps 38 for a semicircular vessel structure and obround end caps 48 for obround vessel structures. The end caps 38, 48 may be unitary with or attached to the curved vessel walls and will be understood to be either fused or permanently attached in a fluid tight, pressure resisting manner, using appropriate means known in the art. The end caps 38, 48 may comprise a lip structure engaged on, e.g. inserted into, the respective end of the tubular structure, for instance by friction fit. For a fluid tight seal, the engagement faces may comprise an O-ring, adhesive or other seal, or combinations thereof. The lip structure and/or the vessel structure may comprise retention grooves for a seal, e.g. for an arrangement of two or more O-rings.

The array 20 is further provided with a hoop 22 constituting a belt structure wrapped around the vessels, wrapping around the outer surface, (here: the mantle constituted by the tubular structures), of the round faces 32, tangentially contacting the ridges 44. It will be appreciated that, in this manner, two lateral vessels 30A, 30B and any number of intermediate vessels (including no intermediate vessel) may be assembled to form an array of a desired size. The hoop 22 is formed as a unitary hoop, or short tube, of obround cross-section. If provided in unitary form, the absence of joints or weld seams provides for a uniform, isotropic load transfer behaviour along the radial extension of the hoop. However, in some embodiments the belt structure may be provided in a different form.

When filled with pressurised gas, walls and plates of the module 10 provide mutual structural support, here by face-to-face abutment. In particular, when filled relatively evenly, it can be assumed the outward pressure from within a vessel on a flat face 46 will be approximately even in two adjacent vessels, such that a flat face 46 exposed to a higher internal pressure can also be assumed to be supported by a correspondingly higher pressure from an adjacent outer flat face 46 or 36, respectively.

The module 10 comprises reinforcing structures or a support configuration in locations without bilateral support, i.e. without support from adjacent pressurised vessels. The lateral vessels 30A, 30B comprise round faces 32 that constitute free faces that are not supported by flat faces 46. The rounder, domed or semicircular profile of the lateral vessels 30 provides for inherently greater stability. In addition or as an alternative to the round profile, the round faces 32 are reinforced by the hoop 22 that allows forces to be transferred between the opposite free walls 32 of an array. As may be imagined, a higher outward pressure of one (e.g. the left) round face 32 of one lateral vessel 30A will result in a reactive force of the hoop 22 and exert a corresponding pressure on the opposite (e.g., right) round face 32 of the other lateral vessel 30B, and vice versa.

The end caps 38, 48 are supported by abutment against the inside faces of the first end plate 12 and the second end plate 14, respectively. The first and second end plates 12, 14 are connected by tension rods 18 reducing a risk of a structural failure of the end caps 38, 48 under high pressures. Conveniently, the rods 18 extend parallel to the extension of the vessels and are located in the interstitial spaces between the curved portions 34, and/or between the ridges 44. As such, the rods may be inside a periphery defined by the hoop 22, and therefore do not increase the overall footprint of the module 10 beyond the periphery of the hoop 22. As shown in FIGS. 2 and 3, the rods 18 are located in the interstitial spaces in the curvature regions next to (here above and below) the wall-to-wall interfaces 36, 46, in the planar extension of the flat portions of the respective vessel wall structure, and on both sides (above and below) of the round faces 32, respectively. This rods 18 thereby effectively confine a vessel 30, 40 between multiple (here: four) rods 18. The rods 18 therefore help to maintain the vessels 30, 40 in position and inhibit movement of a vessel 30, 40 out of alignment (here: restrict movement up or down). The rods 18 constitute connector structures and may be provided by struts, tension bars, or other structures that are suited to connect the first end plate 12 and the second end plate 14 and to provide an improved resistance to outward pressure by the pressurised vessels. Conveniently, the connection between rods 18 and end plates 12, 14 may comprise an adjustable mechanism, such as a threaded connection, to allow the tension to be set to a predetermined level and/or to within a predetermined range.

The assembly allows the vessel walls and reinforcing structures to be made structurally weaker, and therefore using less material, than would otherwise be the case if the vessels were provided as individual units with individual support structures. The array structure effectively avoids the need for individual pressure support structures of full pressure rating for each vessel at the lateral faces, instead utilising pressurised adjacent vessels for mutual structural support under high-pressure conditions. This renders the frame structure of the module 10 highly compact, increasing the volume fraction of pressurised hydrogen per volume relative to alternative structures. This is believed to be of benefit in application scenarios such as hydrogen powered vehicles that may have a predefined battery envelope that for practical purposes cannot, or cannot easily, be increased.

The design allows tubular and hoop structures to be utilised that can be manufactured according to load-optimised properties tangentially and radially along the hoop structure or tubular structure, respectively, while utilising reinforcing support elements in the form of plates at ends of the tubular structures. The load transfer within the assembly is designed such that pressure support is provided by adjacent pressurised vessels, and may additionally utilise tension structures, and/or arrangements for load transfer of pressure at opposite sides of the module 10, as well as combinations thereof.

It will be appreciated that the wall thicknesses and material properties of the first and second end plates, of the rods 18, of the hoop 22 and of the vessel structures are selected according to a nominal pressure the module needs to be able to contain. However, by arranging the vessel walls as an array of adjacent vessels providing mutual support, such as the exemplary face-to-face abutment, each vessel 30, 40 that is part of the module 10 can tolerate higher pressure levels with fewer additional support structures than would be required for individual isolated vessels.

FIG. 5 shows cutaway section view along the length of another hydrogen tank module 10A that is a variant of the tank module 10. In FIG. 5, like numerals are used for like structures described in FIGS. 1 to 4 without repeating the description thereof. The module 10A comprises between a first end plate 12A and a second end plate 14A a vessel array 20A comprising multiple vessels 50 including intermediate vessels and two lateral vessels (lateral vessel not shown in FIG. 5), arranged serially as one row within a hoop 22.

The module 10A comprises, instead of flat end caps 38, 48, domed end caps 58. Compared to flat caps, the domed geometry of the end caps 58 is believed to provide a greater inherent pressure resistance, due to the curved geometry, such that the first and second end plates 12A, 14A may be less strong, or from practically less material to be relatively thinner, than the first and second end plates 12, 14 of the FIG. 1 arrangement. It will be appreciated that the domed geometry results in a free area 58A that may result in an overall lower storage volume inside the vessel for a given envelope (outer circumference) size.

Either or both of the end plates 12, 14 or 12A, 14A may be provided with a manifold 16 or interface elements such as gas passages 17, as well as sensors, indicators, flow control elements and the like. The manifold or interface elements may be arranged to allow pressure equilibration between two or more, or between all, vessels of an array. Several manifold designs and pressure equilibration mechanisms will be known to a skilled person and are not described in more detail herein.

As shown herein, each vessel is closed off by individual end caps 38, 48, 58. The end caps at the first end plate 12, 12A are in fluid connection with a manifold 16 supplying the gas passages 17 for fuel exchange. As an alternative arrangement, some or all of the vessels may share a common end cap structure.

The vessels are illustrated as individual tubular structures arranged side-by-side, such that flat faces of adjacent vessels are in wall-to-wall abutment. In embodiments, two or more vessels are separated by a common vessel wall structure, i.e a single vessel wall structure between two cells. In that case, the mutual pressure support from two adjacent pressurised vessels acts directly on the common vessel wall structure between them. The vessel wall structure may comprise a generally planar area with flat faces on both sides of the vessel wall structure to allow for even pressure exposure on both sides of the wall.

In some embodiments, the vessels may be co-extruded in a common forming operation. For instance, the vessel array may be of hexagonal form, or any multi-tubular form or lamellar form, in which individual chambers are separated by wall structures shared between two chambers.

The rounded profile portions of the semicircular and obround tubular vessels are believed to impart greater pressure resistance than flat faces where the portions are not supported by a pressurised adjacent vessel. As such, free or outward-facing sides of rounded, part-spherical or domed form are believed to be better suited for highly pressurised fluids such as hydrogen. However, the invention may find application in lower pressure fluid storage such as, for instance, LPG containers, in which flat faces may be preferable on free or outward facing surfaces. In some embodiments, the vessel profile may comprise polygonal, for instance hexagonal, octagonal or other structures. The vessel profile may be selected according to an outer circumference of a storage compartment, such as a battery compartment.

The embodiments illustrated in the figures are supported by a single hoop structure 22. Embodiments may comprise two or more hoop structures.

FIGS. 6 to 10 show views of a further variant of the tank modules 10 and 10A, in the form of a hydrogen tank module 10B. The tank module 10B correspond to the tank modules 10 and 10A in several aspects, and so the description is not repeated in detail for each aspect of the tank module 10B. The tank module 10B comprises a vessel array 20B comprising a plurality of vessels 60 including a number of (here: 3) intermediate vessels 60A, 60B, 60C and two lateral vessels 62A, 62B. Each of the vessels 60 is of generally tubular form, wherein the intermediate vessels 60A, 60B, 60C are of obround cross-section and the lateral vessels 62A, 62B are of generally semicircular cross-section, in an arrangement that allows vessel wall structures to be supported by mutual support of adjacent pressurised vessels. Other configurations, such as those described in relation to the tank module 10, may be used. The individual vessels 60 are closed by dome end caps 68 that correspond in profile contour to the cross-section of the vessel tubes. As will be appreciated, one vessel 60 is closed by two end caps 68, and the tank module 10B comprises, here, ten end caps 68 for five vessels 62A, 60A, 60B, 60C, and 62B.

The array of vessels 60 is surrounded by a hoop 22B constituting a belt structure akin to the hoop 22 described in relation to FIGS. 1 to 5. The tank module 10B comprises two end plates 64A, 64B abutting against the end caps 68. Akin to the end plates 12, 14, the end plates 64A, 64B may be of a suitable load-bearing material such as composite material or metal such as steel. In contrast to the flat end plates 12, 14, the end plates 64A, 64B comprise a profiled surface contour comprising recesses complementing the domed curvature of the end caps 68.

The end plates 64A, 64B comprise a silhouette corresponding to the array of side-by-side vessels 60, here in the form of a scalloped silhouette comprising (here) two lateral lobes and six intermediary lobes corresponding to the six outward-facing tube portions of the intermediary vessels. The scalloped silhouette includes interstitial free spaces between lobes that may be used as locating feature for plate-supporting reinforcing structures, such as bands, if desired. For instance, as annotated in FIGS. 9 and 10, a plurality of (here: four) reinforcing bands 69 is wrapped around the end plates 64A, 64B to provide further reinforcement. Although FIGS. 9 and 10 show bands 69, the plate-supporting components may be provided by rods such as rods 18 illustrated in FIGS. 1 to 3.

The vessel arrangement may be symmetric such that two end plates 64A, 64B of identical design may be used in the assembly, however this is not necessarily a requirement of each embodiment. In some embodiments, the end plates 64A, 64B are shaped differently to each other.

The end plates 64A, 64B are provided with holes providing passages and/or access ports for fluid. A first end plate 64A of the end plates is provided with a manifold 66. The manifold 66 provides passages for gas exchange to supply and withdraw gas from each one of the vessels 60. As will be appreciated, the manifold 66 may be configured with a control system to enable a controlled pressure equilibrium between selected ones, or all, of the vessels 60 to within a pre-defined degree of accuracy.

The end plates 64A, 64B are provided with protrusions in the form of connector elements 65 that constitute anchoring structures. The connector elements 65 may be provided as connection for fluid passages and connection to the manifold 66. In the illustrated embodiment, the connector elements 65 are provided as integral structure of the end plates 64A, 64B, and therefore on both end plates 64A, 64B, even though only a first end plate 64A is provided with a manifold 66. The connector elements 65 are used as anchoring elements for connection bands 70. The connection bands 70 are of hoop form and looping around the connector elements of opposing end plates 64A, 64B. Multiple connection bands 70 are connected to the outermost connector elements 65 and extend parallel to the extension of the pressure vessels 60. In the illustrated embodiment, three connection bands 70A, 70B, 70C of hoop form extend on one side of the tank module 10B along the lateral vessel 62A, and three connection bands 70D, 70E, 70F extend on the other side of the tank module 10B along the lateral vessel 62B. The connection bands 70 extend, here, outside the hoop 22B, which is believed to facilitate access for servicing and maintenance inspection. The end plates 64A, 64B comprise an outwardly rounded profile at the contact interfaces with the connection bands 70, to reduce localised stress points on the connection bands 70.

The connection bands 70 may provide plate-supporting components to support the end plates 64A, 64B under tension. To this end, the connection bands 70 may be tensionable, or adjustable, although this is not necessarily a requirement of all embodiments. For instance, the connector elements 65 may provide an adjustable mechanism, to thereby allow a preload, or a degree of tension, of the connection bands 70 to be adjusted. To provide an illustrative example, an adjustment mechanism may include a seating element mounted on a threaded arrangement, so as to adjust the distance of the anchoring location from the end plate. Alternatively, or in addition, an adjustment mechanism may comprise a cam element such as a poly-radial seating element and/or an eccentrically rotatable seating element, whereby rotation of the seating element alters the tension of a tension band. Multiple adjustment mechanisms may be provided, one for each one of the connection bands 70. In another form, the connection bands 70 are of filament wound form, for instance formed by direct deposition using an articulated arm (e.g. a robot arm) in situ. As will be appreciated, such filament wound structures can be provided with a desired stress rating, such that tensioning is not necessarily required.

As best appreciated from the end view in FIG. 10, the connection bands 70 extend at different angles (here, horizontal and about 45 degrees above and below horizontal) from the connector elements 65. Thereby, they extend angularly spaced apart along the perimeter of the outermost vessels. As illustrated, the connection bands 70 extend spaced apart along multiple lines along the lateral vessels 62A, 62B, providing a plate-supporting reinforcement of the end plates 64A, 64B against the cap structures 68. In this manner, the cap structures 68 are reinforced by multiple support structures, including the end plates 64A, 64B and the connection bands 70. In addition, the tank module 10B comprises a plurality of (here: four) connection bands 69 extending parallel to the longitudinal extension of the vessels 60, located in the interstitial spaces of the scalloped end plates 62A, 62B. Connection structures such as the connection bands 69 and/or 70 may be of unitary, continuous form, i.e. formed without seams, to improve homogeneity of their stress rating. Similarly to the vessel wall structures, the bands 69, 70, may be of composite material form, and may be reinforced material, such as fibre reinforced material. The bands walls may comprise several layers of composite material, the layers embedded in a cured resin matrix to form a unitary band structure.

The modules 10, 10A, 10B may be provided inside a housing or casing, for instance if required for handling, labelling or containment purposes. The housing or casing may be part of, or constitute, a support structure. However, any such housing need not necessarily be relied on to provide structural support to the vessels.

Whilst the principle of the invention has been illustrated using exemplary embodiments, it will be understood that the invention is not so limited and that the invention may be embodied by other variants defined within the scope of the appended claims.

1. A storage tank assembly for a pressurised fluid, the storage tank assembly comprising a plurality of individual vessels arranged adjacent to each other, such that pressure from adjacent vessels, when pressurised, provides mutual support for vessel wall structures between them, wherein the individual vessels are tubular structures closed with cap structures, and wherein the storage tank assembly further comprises at least one support structure to support the cap structures.

2. The storage tank assembly according to claim 1, wherein the at least one support structure comprises at least one end plate.

3. The storage tank assembly according to claim 2, wherein the at least one end plate comprises a surface profile complementing a surface profile of the cap structures.

4. The storage tank assembly according to claim 1, wherein the cap structures comprise domed cap structures.

5. The storage tank assembly according to claim 2, comprising at least one pair of end plates, the end plates of a pair provided with a plate-supporting arrangement thereby to reinforce the cap structures.

6. The storage tank assembly according to claim 5, wherein the plate-supporting arrangement comprises components in the form of at least one of rods, bands, and bands of hoop form.

7. (canceled)

8. (canceled)

9. The storage tank assembly according to claim 6, wherein at least one band is anchored to an external structure of at least one end plate.

10. The storage tank assembly according to claim 9, wherein multiple bands are anchored to a common external structure.

11. The storage tank assembly according to claim 6, wherein at least one plate-supporting component extends along at least one of (a) interstitial spaces between individual vessels and (b) outside of laterally outermost vessels.

12. (canceled)

13. The storage tank assembly according to claim 1, wherein the at least one support structure comprises at least one belt structure provided circumferentially around the plurality of vessels.

14. The storage tank assembly according to claim 13, wherein the at least one belt structure surrounds two opposite vessels, thereby to allow mutual transfer of loads between the opposite vessels.

15. (canceled)

16. The storage tank assembly according to claim 1, wherein the vessel wall structure is of reinforced composite material form.

17. The storage tank assembly according to claim 1, wherein the at least one cap structure is integral with a tubular portion of a vessel.

18. The storage tank assembly according to claim 1, wherein the at least one cap structure is a separate component attached to a tubular portion of a vessel.

19. The storage tank assembly according to claim 1, comprising a frame structure in which the vessels are held.

20. The storage tank assembly according to claim 19, wherein the frame structure comprises end plates in abutment with the ends of the vessels.

21. The storage tank assembly according to claim 19, wherein the frame structure comprises one or more fluid ports suitable as at least one of an inlet and an outlet for gas exchange with the vessels.

22. (canceled)

23. The storage tank assembly according to claim 21, wherein at least two fluid ports are in fluid connection with a manifold configured to permit pressure equilibration between at least two vessels.

24. The storage tank assembly according to claim 1, forming part of a pressurised fluid container.

25. The storage tank assembly according to claim 1, forming part of a hydrogen fuel tank.
